(19) United States
(12) Patent Application Publication
(10) Pub. No.: US 2024/0287682 A1
(43) Pub. Date: Aug. 29, 2024

(54) DECORATIVE PLASTIC COMPONENT AND METHOD FOR PRODUCING SUCH A COMPONENT

(71) Applicant: Gerhardi Kunststofftechnik GmbH, Lüdenscheid (DE)

(72) Inventors: Dennis LEMKE, Mettingen (DE); Alexander GOETTGENS, Georgsmarienhuette (DE); Selvedina USANOVIC, Mettmann (DE)

(73) Assignee: Gerhardi Kunststofftechnik GmbH, Lüdenscheid (DE)

(21) Appl. No.: 18/571,323

(22) PCT Filed: Jun. 20, 2022
(86) PCT No.: PCT/EP2022/066762

§ 371 Date: Dec. 18, 2023

(30) Foreign Application Priority Data
Jun. 19, 2021 (DE) 20 2021 002 143.4
Oct. 19, 2021 (DE) 10 2021 127 112.6

(51) Int. Cl. C23C 28/02; B29C 45/00; C23C 22/06; C25D 5/56

(52) U.S. Cl. CPC C23C 28/025; C23C 22/06; C25D 5/56; B29C 2045/0079

(57) ABSTRACT

A decorative plastic component having a coating for representing colored, corrosion-stable metal layers, includes a substrate made up of a plastic, on which a first layer is deposited and on which a zinc, a zinc-nickel or nickel layer is applied. The surface is colored and sealed. Also, a method produces such a decorative plastic component.

The invention relates to a component part manufactured by plastic injection molding, with a coating for presentation of colored corrosion-resistant metal layers, comprising a substrate consisting of plastic. Beyond that, the invention describes a method for manufacture of such a component part.

What is to be understood by coating in the wording of the present invention is the application of a securely adhering layer of a formless substance on a workpiece made from a substrate. This layer and this substrate form an inseparable body of different substances. The final coating, and especially the decorative layer, assume the contact function, i.e. protection against chemical, corrosive and mechanical attack. The decorative layer serves visual or decorative purposes, while the substrate assumes the support function.

In the automotive industry, various and differently decorated plastic component parts are used to boost visual appeal. Conventional surface technologies such as component parts with decorated surfaces include lacquering of plastic surfaces, electroplating of plastic surfaces, coating by means of PVD or related technologies, decoration in the injection-molding machine by film decorations according to the IMD or FIM method and also back-injection of metal foils.

Besides all of these traditional surface technologies, the presentation of metallic surfaces is a particularly trending topic, while at the same time this surface suggests a high-quality, corrosion-resistant and robust impression like no other.

Besides the component parts decorated with genuine metal, i.e. veneered, joined or back-injected component parts with thin stainless-steel or aluminum sheets, metallically coated plastic components are also particularly preferred as decorative elements.

One type of coating with which it is possible to generate visually metallic surfaces is, for example, gas-phase deposition, which includes the PVD method (physical vapor deposition) as well as its modified technologies such as, for example, CVD (chemical vapor deposition) and PeCVD (plasma-enhanced chemical vapor deposition) and others. In these methods, thin metal layers are deposited on a substrate in an evacuated vacuum chamber. The material to be deposited exists in solid form. The vaporized material travels through the coating chamber and encounters the component part to be coated, where it forms a layer by precipitation. Certainly the PVD method is suitable in general for presenting metallic layers; however, it has proved problematic that the very thin metal coating cannot have an adequate resistance to abrasion and corrosion without an additional protective layer. For this reason, it is necessary to apply a protective layer, for example a transparent lacquer system. In order to achieve adequate basic adhesion on the plastic component part to be coated by deposition, lacquering with an adhesion-promoting agent or primer is usually necessary. The advantage of such a coating, however, is the optional creation of colored variants.

A further coating that is very important in industry is deposition of metals on plastic component parts by electroplating. In this case, the parts are first manufactured in the injection-molding process, for example from electroplatable butadiene-containing copolymers such as ABS or ABS/PC. After the injection-molding process, the component parts are first pretreated chemically, after which a first thin and conductive metal layer, usually a thin nickel or copper layer, is deposited autocatalytically on them. In the further electroplating process, further metal layers are then deposited electrolytically, until the electroplating process is finally completed, usually with a deposited chromium layer.

Electroplating achieves a highly esthetic impression, a superbly high resistance to mechanical damage and even a high resistance to media, which is why electroplated component parts are readily built onto the exterior as well as into the interior of automobiles.

In the known practice of deposition by electroplating, galvanization and passivation of metal component parts has been applied heretofore for functional reasons or to meet requirements, namely to increase the corrosion resistance. For this purpose, the zinc surface is treated with different passivation, depending on the required corrosion protection. In the process, a conversion layer is generated by dipping the workpieces in appropriate electrolytes. Beyond that, the color of the surface can be varied by the passivation. The color is developed during the passivation itself by the metallic compounds during the passivation. Consequently, the coloration is a side effect of the passivation. Passivation on the basis of trivalent chromium protects zinc coatings and thus optimizes the corrosion resistance of the layer systems. Different color shades (black, blue, violet, iridescent) resulting from the passivation then permit a color marking of the coated parts. This property is used, among other purposes, in order to be able to distinguish component parts from one another, for example in terms of thread size, diameter, material thickness, etc.

However, the slight color variance must be mentioned as disadvantageous in this type of surface coating. Surface grades and colors from conventional deposition by electroplating usually range from highly glossy through various levels of matt finish to slightly anthracitic and brownish variants achieved by modified electrolytes and processes. Depending on method, these passivation layers can have colors such as (faintly) blue, yellow, black, olive or transparent. In this respect, however, the coloration is merely a side effect, which is generated by the organic and inorganic complex compounds during passivation. The main goal of the passivations is to improve the corrosion resistance of the metal component parts.

The restrictions on the color of electroplated chrome surfaces of plastic component parts has long been tolerated, although the desire for more individuality, design-related freedom and configuration of color and structure of the surfaces has always existed. It is precisely the automotive industry that desires greater leeway in determining the color, especially in the case of metallic surfaces such as electroplated coatings.

Many approaches are known toward presenting surfaces with a colored and simultaneously metallic effect. For example, DE 102 33 120 A1 describes a technology in which a combination of lacquering, gas-phase deposition, such as, for example, a PVD coating, and a shaded, i.e. black-pigmented lacquer is used.

A further technology is described in EP 2 369 032 A1, where the metal layers to be deposited are deposited in colored manner on the substrate via PVD, directly via special metal alloys. In this process, however, priming for promotion of adhesion is likewise necessary, as is a subsequent but then clear lacquering.

DE 10 2010 019 913 A9 also describes gas-phase deposition by means of PVD and further technologies on plastic and metal with the objective of generating colored surfaces that at the same time give a metallic impression. Even in this application, the surface coated by deposition is and must be protected with a final coating.

Furthermore, EP 1 033 416 A1, for example, describes a method in which at least one corrosion-protection layer and an outer layer of zirconium, nitrogen, carbon and/or hafnium is deposited on a substrate by means of PVD coating, wherein the outer layer forms a passive layer due to the action of air or water.

Against this background, the task underlying the present invention is to propose a simple, efficient and resource-sparing technology for creation of a metallic corrosion-resistant and colored plastic component part.

This task is accomplished with the features of claim 1.

With the invention, it is possible selectively to build up, on plastic component parts and preferably on multi-piece plastic component parts, a high-quality corrosion-resistant metal layer that can also be colored.

For this purpose, the component parts to be coated are first manufactured in the plastic injection-molding process from an electroplatable plastic, preferably from polyamide, particularly preferably from an electroplatable butadiene-containing polymer such as ABS or ABS/PC. After the injection-molding process, the component parts are pretreated chemically by direct metallization, particularly preferably by a conventional electroplating process, in order subsequently to deposit autocatalytically on this machined surface a first thin and especially conductive metal layer, usually a thin nickel or copper layer. In the further electroplating process, at least one further metal layer, which preferably represents a glossy or matt copper layer, is then deposited electrolytically.

According to a special configuration of the invention, the first electrically conductive layer also can take place for the further electrolytic deposition by gas-phase deposition such as PVD, CVD or PeCVD. In this case, it is advantageous that, during use of this preliminary coating, it is possible very largely to omit the special electroplatable plastics and the usually chemical pretreatment and thus to use even non-electroplatable plastics such as, for example, polycarbonate, etc.

In further development of the invention, a decorative zinc, nickel-zinc or chrome layer is applied on the further metal layer.

Another further development of the invention provides that the decorative zinc, nickel-zinc or chrome layers also are applied by gas-phase deposition, such as PVD, CVD or PeCVD, or the decorative layers are back-injected as metallic or metallically coated film inserts of the plastic substrate.

Due to the formation of the decorative layers in matt and glossy form, it is also possible to exert an influence directly on the desired presentation of the final layer.

In order to adjust the color of the decorative layers additionally to their metallic natural colors, not only a coloration but also a passivation of the metal layers can also be undertaken by means of organic or inorganic compounds of, for example, carbon compounds or metal salts.

According to a further configuration of the invention, a further top layer of an inorganic layer, of an organic layer or even as a very thin and semitransparent layer is finally applied on the decorative metal layer, by lacquering, powder coating, printing, dipping or gas-phase deposition.

The layer sequence of at least one metallic and one organic or inorganic layer or as a layer sequence of at least one inorganic and one organic layer generates, in combination with the decorative metal layer, the desired color of the decorative plastic component parts.

Since the top layer is exposed under some circumstances to considerable wear, it must have a high mechanical resistance as well as a high resistance to media. The invention therefore provides that an organic or inorganic polymer compound can be applied on the decorative and colored metal layer as the top layer in the form of a transparent, ceramic layer of hard material, especially of AlSiₓO_{y}N_{z}, AlOₓN_{y}, Al₂O₃ or SiO₂. This layer of hard material represents a transparent scratch-proof layer on the coloring and decorative metal layer. In addition, it acts as a barrier layer or diffusion protection layer, whereby the chemical resistance of the underlying metal layers is further improved.

Exemplary embodiments of the invention are illustrated in the drawing and will be described in more detail in the following. In the drawing documents, like reference symbols denote like layers, and

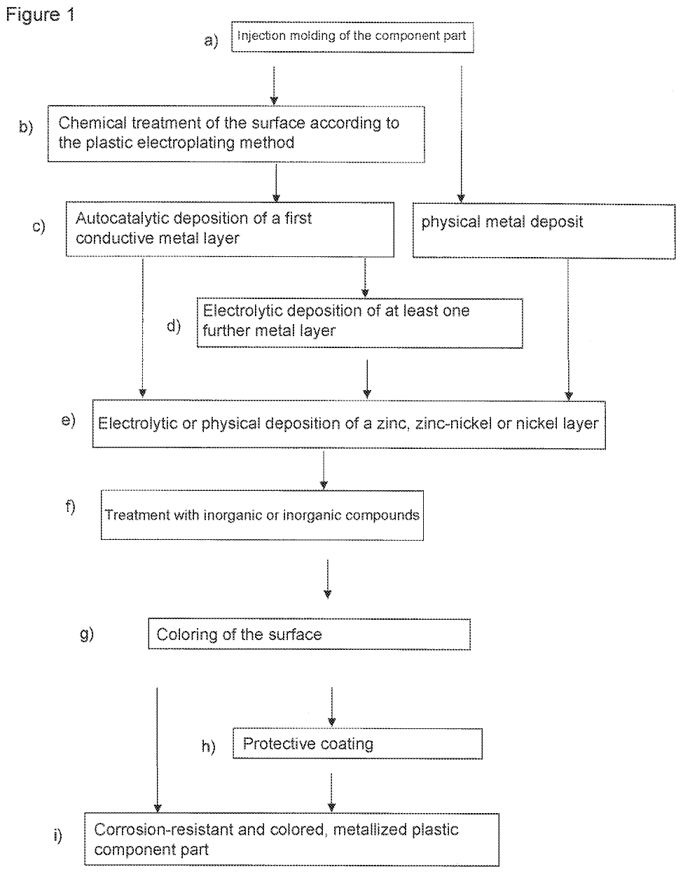

FIG. 1 shows a process sequence of the subject matter according to the invention;

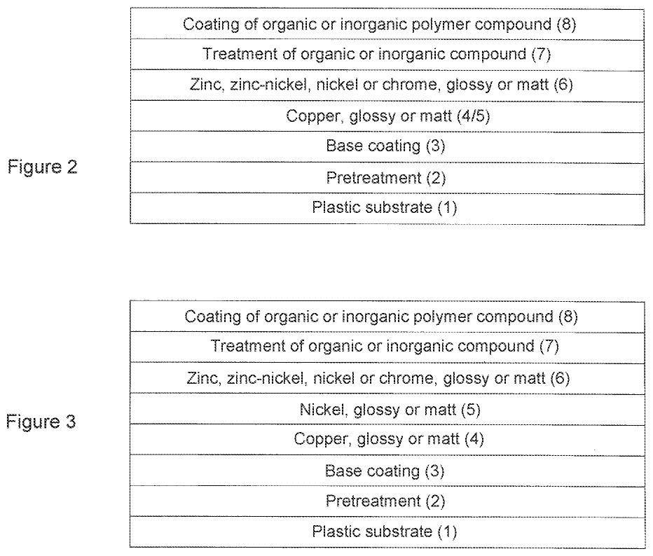

FIG. 2 shows a cross section through the layer structure together with process steps of a second subject matter according to the invention;

FIG. 3 shows a cross section through the layer structure together with process steps of a third subject matter according to the invention;

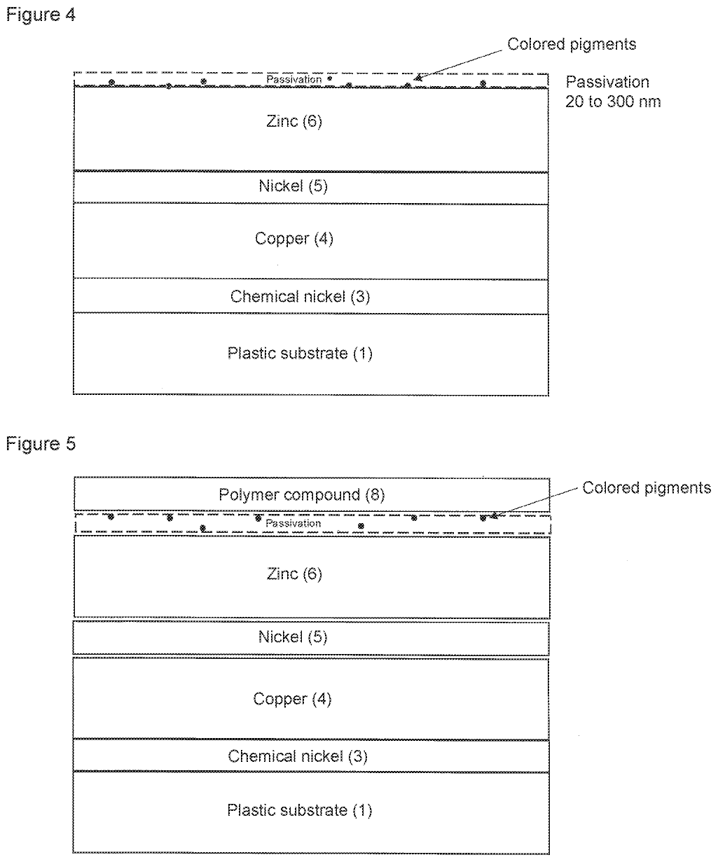

FIG. 4 shows a cross section through the layer structure of a subject matter according to the invention in modified presentation;

FIG. 5 shows a cross section through the layer structure of a subject matter according to the invention in a further presentation.

The subject matter illustrated in FIG. 1 shows a component part (a), manufactured in the injection-molding process, made from a plastic substrate (1). By means of chemical pretreatment (2), the surface of the electroplatable plastic material (b) is processed for subsequent autocatalytic deposition of a first conductive base coating (3) in the form of a metal layer (c). In a further embodiment of the invention, the first conductive metal layer (c) is applied by gas-phase deposition, for example by PVD, CVD or PeCVD methods.

The first (base) coating (3) preferably consists of an element or a compound of several elements from the group including zirconium, titanium, chromium, tin and zinc, copper or preferably nickel.

At least one further middle layer (d), preferably up to copper, which as a metallic intermediate layer (4) acts in leveling and binding manner, is deposited, preferably electrolytically, on this first base coating (3). The deposition of copper takes place from cyanide-containing or sulfuric acid electrolytes. The level of gloss of the surface can be adjusted from matt to glossy by the addition of substances.

In the next step, a decorative layer (5), preferably of nickel, is applied electrolytically. The level of gloss of the decorative layer (5) can be adjusted from matt to glossy by the addition of organic substances. If the nickel layer is to be adjusted to matt, special matt nickel electrolytes with finely disperse solutions are used; in the case of glossy nickel plating, special organic glossy nickel substances are used.

In a modification, the decorative layer (5) can be formed from an element or a compound of several elements from the group including zinc, zinc-nickel or chrome. In the case of zinc, the adjustment from matt to glossy can take place electrolytically as acid electrolyte, alkaline cyanide-free electrolyte and alkaline cyanide-containing electrolytes. Alternatively, the decorative layer (5) can also be applied (e) directly electrolytically or physically even with omission of the metallic intermediate layer (4).

A treatment (f) with organic or inorganic compounds (6) then ensures a passivation of the surface and acts as adhesion promoter for a coloration of the metallic decorative coating (g), on which a top layer (h), preferably transparent or coloring and semitransparent, can finally still be formed by deposited organic or inorganic polymer compounds (7). In this connection, passivation means the spontaneous development or purposeful generation of a nonmetallic protective layer on a metallic material, in order to prevent or greatly slow down the oxygen corrosion of the base material.

The layer (6) is colored by means of alternating current in a coloring metal-salt-containing electrolyte, the metal ions of which penetrate into the layer (6). Alternatively, a dip-coloring method may also be used, in which the layer (6) is dipped into a coloring solution. Coloring particles become included in the pores by absorption.

According to the design of the setup described in FIG. 1, it is therefore possible to manufacture a metallic, corrosion-resistant and colored plastic component part (1).

The subject matter illustrated in FIG. 2 describes a basic structure of the coating according to the invention, in which a first set of metallic and conductive base layers (3) is deposited on the substrate (1) by conventional plastic electroplating pretreatment, by physical deposition or by direct metallization (2), and thereon an organic or metallic layer (4, 5) of preferably copper, which receives the decorative zinc, zinc-nickel, nickel or chrome coating (6), which can be passivated and colored by treatment of an organic or inorganic compound (7), is optionally applied in reinforcing, leveling and binding manner. For protection of the metallic decoration layer from environmental influences or attacks by media, this is provided with a further coating of organic and inorganic polymer compounds (8).

The subject matter illustrated in FIG. 3 again comprises a plastic substrate 1. Thereon a first metallic and conductive base coating (3), on which an organic or metallic layer (4) of preferably copper is optionally deposited by conventional plastic electroplating, by physical deposition or by direct metallization (2), is applied in reinforcing, leveling and binding manner. In this illustration of the configuration according to the invention, and in contrast to the exemplary embodiment according to FIG. 2, yet a further metal deposit of preferably nickel or other metals (5) is applied that receives the decorative zinc, zinc-nickel, nickel or chrome coating (6), which can be passivated and colored by treatment of an organic or inorganic compound (7). For protection of the metallic decoration layer from environmental influences or attacks by media, this is provided with a further coating of organic and inorganic polymer compounds (8).

Compared with the prior art, galvanization is used in the present invention not as a functional layer but instead as a decorative layer. In this respect, the main objective of the passivation is to enable the inclusion of colored pigments and thus to offer a broad color spectrum. Due to the method according to the invention, it is possible to apply the most diverse colors; from pink to violet, bronze to gold, etc. For this purpose, the typical coloring solutions or colored pigments from the coloration of aluminum are used. In contrast to an anodized aluminum, the colored pigments are included not so deeply but instead only superficially in the zinc surface.

In the case of aluminum and zinc, an oxide layer is formed in the normal atmosphere. This oxide layer protects the metal. In order to increase the corrosion resistance, the oxide layer can be further built up or treated. Whereas it is only by a chemical conversion by means of passivation that the oxide layer on zinc can be developed minimally from 20 to 300 nm, the oxide layer on aluminum can be built up electrolytically to 30 μm. This is not possible in the case of zinc, for which an oxide layer can be formed only chemically but not electrolytically.

It has been found that, due to the limited development of the oxide layer, the colored pigments lie only very superficially on the zinc surface; thus they can be easily wiped off. Consequently, the passivation layer containing the included colored pigments is not resistant to wiping. The surface is also not abrasion-resistant. Therefore it is protected from abrasion and scratches by applying a coating (8) by means of organic and/or inorganic polymer compounds, and/or ceramic coatings and/or nanoparticles.

By weighing the needed effort against the achieved results, it has been found after demanding series of tests that the following process sequence is the most convincing:

The build-up of layers according to the invention takes place on a component part made from a substrate (1) consisting of plastic (a). The component part is subjected to a conventional plastic pretreatment (2) by roughening and activation by means of palladium or else chromium-free coating (possibly also direct metallization) up to copper, whereby a copper layer (4) is generated in matt or glossy form.

Thereafter a nickel layer (5) is generated. It is applied electrolytically. The nickel layer has a thickness of 1 to 20 μm. It acts as a barrier layer, in order to prevent a diffusion of zinc into the copper and/or as a structuring layer, in order, for example, to achieve different matt shades and at the same time to generate a diffusion barrier. Consequently, the nickel layer (5) functions simultaneously as a diffusion barrier.

Then zinc is applied electrolytically, and specifically in a thickness between 5 and 30 μm. This zinc layer (6) can be deposited in a one-stage or multi-stage process. The coating times range between 5 minutes and 2 hours at temperatures from RT to 40° C.

After that, the component part is bright-dipped in 0.3 to 1% nitric acid at temperatures from RT to 30° C. for a duration from 5 seconds to 2 minutes. The bright-dipping brings about a clearing of the surface of the zinc layer (6), in order that a subsequent passivation solution can be deposited.

After the component part has been bright-dipped, it is passivated. It is passivated in trivalent chromium passivation solutions. These can be varied to achieve passivation in thin layers and or thick layers, depending on desired layer thickness and inclusion of color. The passivations can range from transparent through blue to a passivation with thick layer.

After that the component part is colored in inorganic and/or organic and/or electrolytic compounds (7), and specifically at a temperature from RT to 40° C. for a duration of 5 seconds to 60 minutes. In the process, the colored pigments settle only superficially in the boundary layer or so-called conversion layer, which is only 20 nm to at most 300 nm thick. Preferably, coloring takes place in a dip tank. Such coloring represents a separate process step.

Then the component parts are provided with a protective layer (8) of organic and/or inorganic polymer compounds and/or nanocoat compounds and/or ceramic hybrid compounds. This protective layer (8) is applied either by a dip process and/or a spray process in a thickness of 0.5 μm to 40 μm and it acts not only as protection against abrasion but also as protection against UV rays.

Between the said treatment steps, the component part can be dried and/or artificially aged, in other words tempered.

With the processes described in the foregoing, it is possible to manufacture plastic component parts having any desired colored, metallic coating. For this purpose, the component part—according to the invention—is, among other treatments, galvanized, then passivated and colored. Thus the galvanization is used here not for functional reasons such as prevention of corrosion in the case of metal component parts, but instead for decorative reasons. This approach is unusual, because the galvanization as understood among experts is normally used for corrosion protection. However, since plastic component parts do not corrode, and since aside from that galvanization causes additional costs, the experts have had no reason heretofore to galvanize plastic component parts. It is only due to the present invention that galvanization of plastic component parts has become a meaningful and advantage-creating application, namely the possibility of coloring the metallically coated plastic component parts in all desired colors of the color spectrum. This was not possible until the present invention. According to the invention, and in contrast to the galvanization of metal component parts, this coloring takes place in a separate processing step, preferably in a dip tank.

1. Method A method for the manufacture of a decorative plastic component part, comprising the following process steps:
injection-molding of the component part (1);
chemical pretreatment (2) of the component part (1);
application of a first, metallically conductive base coating (3);
application of a leveling and binding intermediate layer (4, 5);
application of the intermediate layer (4, 5) as a metallic layer;
application of the first intermediate layer (4) as a copper layer;
application of a further intermediate layer (5) on the first intermediate layer (4) as a further metal deposit;
application of the second intermediate layer (5) as a nickel layer;
application of a decorative zinc coating (6)
of electrolytic zinc in a thickness between 5 and 30 μm with coating times between 5 minutes and 2 hours at temperatures from room temperature to 40° C.;
performance of a bright dipping in 0.3 to 1% nitric acid at temperatures from room temperature to 30° C. and a duration between 5 seconds and 2 minutes;
passivation of a top layer (7) for coloring the coating (6):
coloring with inorganic or organic or electrolytic compounds at a temperature from room temperature to 40° C. for a duration of 5 seconds to 60 minutes;
application of a protective layer (8) of organic or inorganic polymer compounds.

2. The method according to claim 1, wherein the first base coating (3) is deposited autocatalytically.

3. (canceled)

4. The method according to claim 1, wherein the first base coating (3) is deposited physically.

5. The method according to claim 1, wherein the intermediate layer (4, 5) is applied in reinforcing manner.

6-9. (canceled)

10. The method according to claim 1, wherein the further metal deposit (5) of nickel is applied in a thickness of 1 to 20 μm.

11-12. (canceled)

13. The method according to claim 1, wherein the decorative zinc layer is applied by gas-phase deposition such as PVD, CVD or PeCVD.

14-15. (canceled)

16. The method according to claim 1, wherein the coating (8) is applied as a transparent, ceramic layer of hard material, especially of AlSiₓO_{y}N_{z}, AlOₓN_{y}, Al₂O₃ or SiO₂.

17. The method according to claim 16, wherein the protective layer (8) is applied by a dip process and/or a spray process in a thickness of 0.5 μm to 40 μm.

18. A decorative plastic component part with a coating for presentation of colored, corrosion-resistant metal layers, comprising a substrate (1) comprising plastic (a), on which a first layer (c) is deposited and a zinc, zinc-nickel or nickel layer (6) (e) is applied, the surface of which is colored and sealed (f).

19. The decorative plastic component part according to claim 18, wherein the substrate (1) is pretreated chemically.

20. The decorative plastic component part according to claim 18, wherein the first layer is deposited autocatalytically.

21. The decorative plastic component part according to claim 18, wherein the first layer is deposited physically.

22. The decorative plastic component part according to claim 18, wherein a second metal layer is deposited electrolytically (d).

23. The decorative plastic component part according to claim 18, wherein a protective layer (8) (g) is deposited on the surface.

24. The decorative plastic component part according to claim 18, wherein the first layer is formed as an organic layer (2), metallic layer (3) or a layer sequence of at least one organic layer (2) and at least one metallic layer (3).

25. The decorative plastic component part according to claim 18, wherein the metallic layer (3) comprises an element or a compound of several elements from the group including zirconium, titanium, chromium, tin and zinc.

26. The decorative plastic component part according to claim 18, wherein the protective layer (8) is formed as an inorganic layer (5), as a further metallic layer, as an organic layer (6), as a layer sequence of at least one inorganic and one organic layer or as a layer sequence of at least one further metallic layer and one organic layer.
